(19) United States
(12) Patent Application Publication
(10) Pub. No.: US 2025/0192295 A1
(43) Pub. Date: Jun. 12, 2025

(54) CAP PLATE ASSEMBLY AND BATTERY CELL INCLUDING THE SAME

(71) Applicant: DONG YANG PISTON CO., LTD., Ansan-si (KR)

(72) Inventors: Zuo Jia WANG, Hwaseong-si (KR); Su Dong JANG, Incheon (KR); Woo Seok SHIM, Gunpo-si (KR); Ju Hyun SUN, Siheung-si (KR); Jeong Keun LEE, Incheon (KR)

(21) Appl. No.: 18/964,157

(22) Filed: Nov. 29, 2024

(30) Foreign Application Priority Data
Dec. 12, 2023 (KR) 10-2023-0180121

(51) Int. Cl. H01M 50/195; H01M 50/159; H01M 50/172; H01M 50/55; H01M 50/552; H01M 50/562

(52) U.S. Cl. CPC H01M 50/195; H01M 50/172; H01M 50/55; H01M 50/552; H01M 50/562; H01M 50/159

(57) ABSTRACT

Provided is a cap plate assembly provided to cover a cell case of a secondary battery, the cap plate assembly including a top plate having at least a portion penetrated to form a first accommodation hole for connecting an inside and outside of the cell case, and a first electrode unit coupled to the first accommodation hole from above and below the top plate, wherein the first electrode unit includes a first terminal plate held and mounted on the top plate, a first airtight member provided to separate the first terminal plate from the top plate, a first electrode terminal inserted and coupled into the first through hole so as to electrically connect from the inside of the cell case to the first terminal plate, and a first sub-plate connected to a bottom of the first electrode terminal.

### CROSS-REFERENCE TO RELATED PATENT APPLICATION

This application claims the benefit of Korean Patent Application No. 10-2023-0180121, filed on Dec. 12, 2023, in the Korean Intellectual Property Office, the disclosure of which is incorporated herein in its entirety by reference.

### BACKGROUND OF THE INVENTION

### 1. Field of the Invention

The present invention relates to a cap plate assembly and a battery cell and, more particularly, to a cap plate assembly used in a secondary battery, and a battery cell including the same.

### 2. Description of the Related Art

Secondary batteries generally used in electric vehicles and hybrid vehicles with high power consumption require long-term operation and high-power operation, and thus are being used in the form of a battery module in which a plurality of batteries are electrically connected using a bus bar into a single unit. Alternatively, the secondary batteries may also be used in the form of a single battery depending on the type of an external device to which they are applied, e.g., a mobile device or an uninterruptible power supply.

Battery modules are preferred as fuel cells for electric vehicles and hybrid vehicles due to output and capacity issues, and may increase an output voltage or output current depending on the number of batteries included.

The outputs of fuel cell charging systems are continuously increasing, and the safety regulations for battery systems are being tightened accordingly. However, when a dangerous situation occurs due to a short circuit, high temperature, or overcurrent of the battery, the material of battery components may not maintain the flame retardancy to instantaneously cause ignition or explosion.

As such, materials with high flame retardancy are being used and the amount of a carbon material added is decreasing.

### SUMMARY OF THE INVENTION

The present invention provides a cap plate assembly capable of achieving high stability in electrical conductivity, sufficient mechanical strength, high mechanical and thermal shock resistance, and good injection moldability by using a conductive plastic material, and a battery cell including the same. However, the above description is merely an example, and the scope of the present invention is not limited thereto.

According to an aspect of the present invention, there is provided a cap plate assembly provided to cover a cell case of a secondary battery, the cap plate assembly including a top plate having at least a portion penetrated to form a first accommodation hole for connecting an inside and outside of the cell case, and a first electrode unit coupled to the first accommodation hole from above and below the top plate, wherein the first electrode unit includes a first terminal plate held and mounted on the top plate so as to be connected to a bus bar for connecting a plurality of cells at the outside of the cell case, a first airtight member including a first terminal holder for holding the first terminal plate, further including a first through hole provided inside the first accommodation hole, provided to separate the first terminal plate from the top plate, and made of a polymer composite including carbon nanotubes, a first electrode terminal inserted and coupled into the first through hole so as to electrically connect from the inside of the cell case to the first terminal plate, and a first sub-plate electrically connected to the first electrode terminal, and connected to a bottom of the first electrode terminal.

The first airtight member may be made of a polymer composite including 0.3 vol % to 3 vol % of carbon nanotubes.

The first airtight member may be insert-molded with the top plate and the first terminal plate so as to be formed between the top plate and the first terminal plate.

The first electrode terminal may be formed by laminating a first material having the same main component as the first terminal plate, and a second material having the same main component as the first sub-plate, in a widthwise or lengthwise direction of the top plate.

The first electrode terminal may include a core made of the first material and having an upper surface joined to the first terminal plate, and a cladding made of the second material, provided to surround an outer surface of the core, and having a lower surface joined to the first sub-plate.

The first electrode terminal may be formed by laminating an upper layer made of the first material having the same main component as the first terminal plate, and a lower layer made of the second material having the same main component as the first sub-plate, in a height-wise direction of the cap plate assembly.

The cap plate assembly may further include a third airtight member coupled to a bottom of the top plate to support the first sub-plate.

According to another aspect of the present invention, there is provided a battery cell including an electrode assembly including first and second electrodes provided on both surfaces of a separator, a cell case having an electrode accommodator to house the electrode assembly, and a cap plate assembly provided to cover a top of the cell case, and including a first electrode unit mounted in a conductive state on a top plate including a first accommodation hole for connecting an inside and outside of the cell case, so as to be connected to the first electrode, and a second electrode unit mounted in an insulating state through a second accommodation hole of the top plate so as to be connected to the second electrode, wherein the first electrode unit includes a first terminal plate held and mounted on the top plate so as to be connected to a bus bar for connecting a plurality of cells at the outside of the cell case, a first airtight member including a first terminal holder for holding the first terminal plate, further including a first through hole provided inside the first accommodation hole, provided to separate the first terminal plate from the top plate, and made of a polymer composite including carbon nanotubes, a first electrode terminal inserted and coupled into the first through hole so as to electrically connect from the inside of the cell case to the first terminal plate, and a first sub-plate electrically connected to the first electrode terminal, and connected to a bottom of the first electrode terminal.

The first airtight member may be made of a polymer composite including 0.3 vol % to 3 vol % of carbon nanotubes.

The second electrode unit may include a second terminal plate held and mounted on the top plate so as to be connected to the bus bar, a second airtight member including a second terminal holder for holding the second terminal plate, further including a second through hole provided inside the second accommodation hole, and provided to separate the second terminal plate from the top plate, a second electrode terminal inserted and coupled into the second through hole so as to electrically connect from the inside of the cell case to the second terminal plate, and a second sub-plate electrically connected to the second electrode terminal, and connected to a bottom of the second electrode terminal.

The second electrode terminal may be formed by laminating a first material having the same main component as the second terminal plate, and a second material having the same main component as the second sub-plate, in a widthwise or lengthwise direction of the top plate.

The second electrode terminal may include a core made of the first material and having an upper surface joined to the second terminal plate, and a cladding made of the second material, provided to surround an outer surface of the core, and having a lower surface joined to the second sub-plate.

The second electrode terminal may be formed by laminating an upper layer made of the first material having the same main component as the second terminal plate, and a lower layer made of the second material having the same main component as the second sub-plate, in a height-wise direction of the cap plate assembly.

### BRIEF DESCRIPTION OF THE DRAWINGS

The above and other features and advantages of the present invention will become more apparent by describing in detail embodiments thereof with reference to the attached drawings in which:

FIG. 1 is a perspective view of a cap plate assembly according to an embodiment of the present invention;

FIG. 2 is an exploded perspective view of a cap plate assembly according to an embodiment of the present invention;

FIG. 3 is a cross-sectional view of a cap plate assembly according to an embodiment of the present invention;

FIGS. 4 and 5 are perspective views of first electrode terminals of a cap plate assembly, according to various embodiments of the present invention; and

FIG. 6 is a cross-sectional view of a battery cell according to an embodiment of the present invention.

### DETAILED DESCRIPTION OF THE INVENTION

Hereinafter, the present invention will be described in detail by explaining embodiments of the invention with reference to the attached drawings.

The invention may, however, be embodied in many different forms and should not be construed as being limited to the embodiments set forth herein; rather, these embodiments are provided so that this disclosure will be thorough and complete, and will fully convey the concept of the invention to one of ordinary skill in the art. In the drawings, the thicknesses or sizes of layers are exaggerated for clarity and convenience of explanation.

Embodiments of the invention are described herein with reference to schematic illustrations of idealized embodiments (and intermediate structures) of the invention. As such, variations from the shapes of the illustrations as a result, for example, of manufacturing techniques and/or tolerances, are to be expected. Thus, the embodiments of the invention should not be construed as limited to the particular shapes of regions illustrated herein, but are to include deviations in shapes that result, for example, from manufacturing.

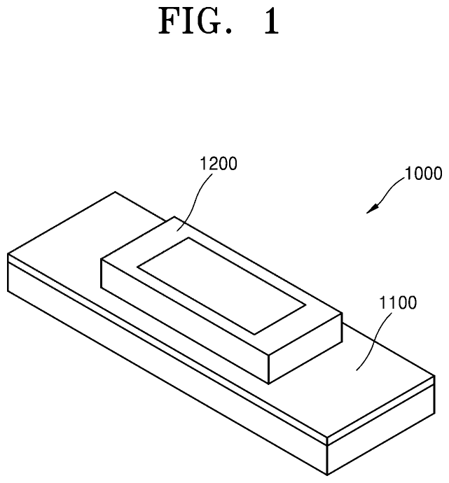

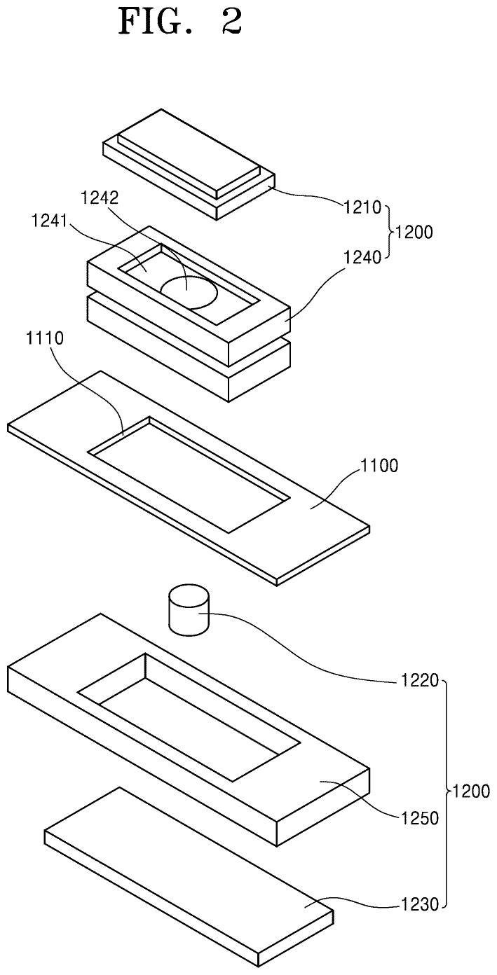

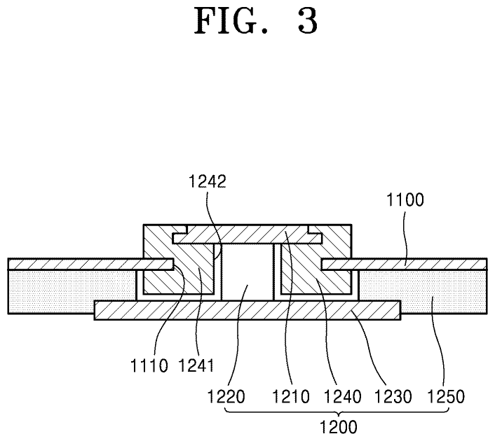

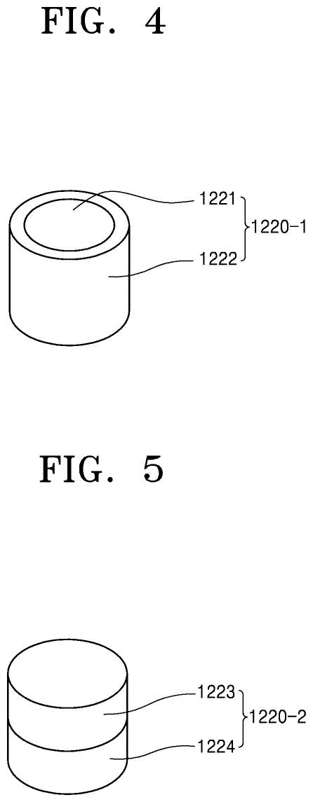

FIG. 1 is a perspective view of a cap plate assembly 1000 according to an embodiment of the present invention, FIG. 2 is an exploded perspective view of the cap plate assembly 1000 according to an embodiment of the present invention, FIG. 3 is a cross-sectional view of the cap plate assembly 1000 according to an embodiment of the present invention, and FIGS. 4 and 5 are perspective views of first electrode terminals of the cap plate assembly 1000, according to various embodiments of the present invention.

Initially, as illustrated in FIG. 1, the cap plate assembly 1000 according to an embodiment of the present invention may mainly include a top plate 1100 and a first electrode unit 1200.

The top plate 1100 may be provided to cover the top of a cell case of a secondary battery, and at least a portion thereof may be penetrated to form a first accommodation hole 1110 for connecting the inside and outside of the cell case.

The top plate 1100 may be mounted in an opening of the cell case of the battery cell to seal the cell case. For example, the cell case and the top plate 1100 may be made of a first material and welded to each other, and the first material may include aluminum, aluminum alloy, or the like.

The top plate 1100 may include an electrolyte inlet, a vent hole, a terminal hole, etc. The electrolyte inlet (not shown) is an inlet through which an electrolyte may be injected into the cell case after the top plate 1100 is coupled to the cell case. After the electrolyte is injected, the electrolyte inlet may be sealed with a sealing plug (not shown).

As illustrated in FIGS. 2 and 3, the first accommodation hole 1110 at least partially penetrated in a vertical direction may be provided in the top plate 1100.

Specifically, the first accommodation hole 1110 is a hole penetrating through the top plate 1100 to connect the top and bottom of the top plate 1100. The periphery and inner surface of the first accommodation hole 1110 may be surrounded by a first airtight member 1240 to be described below.

A first support hole at least partially penetrated in a vertical direction may be further provided in the top plate 1100.

The first electrode unit 1200 is a coupled structure formed to connect the inside of the sealed battery cell and a bus bar provided outside.

The first electrode unit 1200 may include a positive electrode terminal mounted in a conductive state on the top plate 1100, or a negative electrode terminal mounted in an insulating state on the top plate 1100.

The first electrode unit 1200 may be coupled to the first accommodation hole 1110 from above and below the top plate 1100.

Specifically, the first electrode unit 1200 may include a first terminal plate 1210, the first airtight member 1240, a first electrode terminal 1220, and a first sub-plate 1230.

As illustrated in FIGS. 2 and 3, the first terminal plate 1210 may be held and mounted on the top plate 1100 so as to be connected to the bus bar for connecting a plurality of cells at the outside of the cell case.

An upper surface of the first terminal plate 1210 may be provided in a shape corresponding to the shape of the bus bar, so as to be coupled to the bus bar, and may be surface-treated to increase the efficiency of conduction in contact with the bus bar.

A protrusion may be provided on side surfaces of the first terminal plate 1210. The protrusion may be formed by welding at least a portion of the perimeter of the first terminal plate 1210, and the side surfaces of the first terminal plate 1210 may be provided in a stepped structure with a lower portion protruding more than an upper portion.

The first terminal plate 1210 may be made of the first material, and the first material may include aluminum, aluminum alloy, or the like. Alternatively, when the bus bar is made of copper, copper alloy, nickel, nickel alloy, or the like, the first terminal plate 1210 may be made of the same material.

As illustrated in FIGS. 2 and 3, a first terminal holder 1241 for holding the first terminal plate 1210 may be provided on the first airtight member 1240.

To fix the first terminal plate 1210 to the first airtight member 1240, a fixing groove into which the protrusion is inserted after the first terminal plate 1210 is mounted in the first terminal holder 1241 may be provided in the first airtight member 1240.

The fixing groove may be provided in the first airtight member 1240 in a shape corresponding to the protrusion at a position of corresponding to the perimeter of the first terminal plate 1210.

At least a portion of the first airtight member 1240 may be provided on the top plate 1100, and the first terminal holder 1241 may be provided in a surface opposite to the surface in contact with the top plate 1100, thereby separating the first terminal plate 1210 from the top plate 1100.

A first through hole 1242 may be provided in the first airtight member 1240 inside the first accommodation hole 1110. Specifically, at least a portion of the first airtight member 1240 may be provided inside the first accommodation hole 1110 to block the inner surface of the first accommodation hole 1110 from the outside.

In this case, the first accommodation hole 1110 may not be completely filled with the first airtight member 1240, the first through hole 1242 smaller than the first accommodation hole 1110 may be provided inside the first accommodation hole 1110, and at least a portion of the first electrode unit 1200 may be inserted through the first through hole 1242.

The first accommodation hole 1110 may be provided as a through hole of various shapes such as circular, oval, and rectangular shapes.

The first airtight member 1240 may be provided to surround the first accommodation hole 1110 of the top plate 1100 and fix the first terminal plate 1210.

Specifically, the first airtight member 1240 may be formed through insert molding with the top plate 1100 and the first terminal plate 1210.

That is, the first airtight member 1240 may be formed by inserting a molten material around the first accommodation hole 1110 of the top plate 1100 and between the top plate 1100 and the first terminal plate 1210 in a mold in which the top plate 1100 and the first terminal plate 1210 are fixed.

Because the first airtight member 1240 is insert-molded between the top plate 1100 and the first terminal plate 1210, the top plate 1100, the first airtight member 1240, and the first terminal plate 1210 may be easily coupled to each other without performing individual assembly processes.

In addition, the first terminal plate 1210 may be easily fixed to the first airtight member 1240, and the space between the first terminal plate 1210 and the first airtight member 1240 may be sealed without a sealing member such as a gasket.

The first airtight member 1240 may be made of a polymer composite including carbon nanotubes. The polymer composite may have a microstructure in which an electrically conductive material such as carbon nanotubes is dispersed in a matrix made of a polymer.

The polymer of the matrix may include one or more of polyphenylene sulfide, polybutylene terephthalate, liquid crystal polymer, polyether ether ketone, polyphthalamide, polyamide, and polycarbonate.

For example, the first airtight member 1240 may be made of a polymer composite including 0.3 vol % to 3 vol % of carbon nanotubes.

Compared to carbon black, carbon nanotubes have higher electrical conductivity, mechanical strength, mechanical and thermal shock resistance, and injection moldability. In addition, compared to carbon fiber, carbon nanotubes exhibit higher electrical conductivity, mechanical and thermal shock resistance, and injection moldability.

Electrical conductivities of carbon nanotubes, carbon black, and carbon fiber may be compared as described below. An electrical resistance value of 1000Ω to 2000Ω is exhibited when a polymer resin includes 1 vol % of carbon nanotubes. On the other hand, an electrical resistance value of 1000Ω to 10000Ω is exhibited when the polymer resin includes 30 vol % of carbon black, and an electrical resistance value of 1000Ω to 5000Ω is exhibited when the polymer resin includes 8 vol % of carbon fiber.

That is, to obtain the minimum electrical resistance value of about 1000Ω, carbon black needs to be added by 30 vol % and carbon fiber needs to be added by 8 vol % of the polymer resin. On the other hand, carbon nanotubes may be added by 1 vol % to obtain the same electrical resistance value, and thus flame retardancy is remarkably increased.

The polymer composite may be produced by adding carbon nanotubes and a dispersant to a liquid polymer, stirring, and then solidifying. In this case, the dispersant may be added in a range of 10 wt % to 40 wt % of carbon nanotubes.

The liquid polymer added with the dispersant and carbon nanotubes may be injection-molded through an insert molding machine, and then solidified to form the first airtight member 1240.

As illustrated in FIGS. 2 and 3, the first sub-plate 1230 may be connected to the bottom of the first electrode terminal 1220 so as to be electrically connected to the first electrode terminal 1220. For example, the first sub-plate 1230 may be provided in a flat panel shape, and a surface thereof may be joined to the first electrode terminal 1220 while the other surface thereof may be joined to a tab inside the cell case, thereby electrically connecting from the tab to the first electrode terminal 1220.

The first electrode terminal 1220 may be inserted and coupled into the first through hole 1242 so as to electrically connect from the first sub-plate 1230 provided inside the cell case, to the first terminal plate 1210.

The first sub-plate 1230 may be made of the first material having the same main component as the first terminal plate 1210, and the material of the first sub-plate 1230 may be selected based on the polarity of the first electrode unit 1200.

For example, when the first electrode unit 1200 is a positive electrode, the first sub-plate 1230 may be a metal having aluminum, aluminum alloy, or the like as a main component, and when the first electrode unit 1200 is a negative electrode, the first sub-plate 1230 may be a metal made of copper, copper alloy, nickel, nickel alloy, or the like.

Specifically, for example, when the first electrode unit 1200 is a positive electrode, the first terminal plate 1210 and the first sub-plate 1230 may be made of materials having the same main component, and the first electrode terminal 1220 for connecting the first terminal plate 1210 and the first sub-plate 1230 may also be made of a material having the same main component as the first terminal plate 1210 and the first sub-plate 1230.

When the first electrode unit 1200 is a negative electrode, the first terminal plate 1210 may be made of the first material, and the first sub-plate 1230 may be made of a second material different from the first material.

In another embodiment, when the first electrode unit 1200 is a positive electrode, the bus bar may be made of a material different from the first sub-plate 1230. For example, the first sub-plate 1230 may be made of the first material, and the first terminal plate 1210 connected to the bus bar may be made of the second material different from the first material.

To electrically connect the first terminal plate 1210 and the first sub-plate 1230, which are made of different materials, the first electrode terminal 1220 formed by laminating the first and second materials may be mounted between the first terminal plate 1210 and the first sub-plate 1230 and joined to the materials having the same main components.

For example, as illustrated in FIG. 3, the first electrode terminal 1220 may be formed by laminating the first material having the same main component as the first terminal plate 1210, and the second material having the same main component as the first sub-plate 1230, in a widthwise or lengthwise direction of the top plate 1100.

Specifically, for example, as illustrated in FIG. 4, the first electrode terminal 1220-1 may include a core 1221 and a cladding 1222.

The core 1221 may be provided in various shapes such as circular, oval, and rectangular shapes.

The core 1221 may be made of the first material, and the first material may include aluminum, aluminum alloy, or the like.

The cladding 1222 may be provided to surround the outer surface of the core 1221. For example, the cladding 1222 may be provided to surround a direction perpendicular to an axial direction of the core 1221.

The cladding 1222 may be made of the second material, and the second material may include copper, copper alloy, nickel, nickel alloy, or the like.

The cladding 1222 and the core 1221 are a laminated structure of heterogeneous materials in which facing surfaces of the cladding 1222 and the core 1221 are coupled to each other through structural destruction, coupling, and stabilization due to high heat and pressure.

Because the cladding 1222 is formed outside the core 1221, the corrosion and damage of the core 1221 may be prevented even when an electrolyte accommodated in the cell case flows to the first electrode terminal 1220.

An upper surface of the first electrode terminal 1220-1 may be joined to the first terminal plate 1210, and a lower surface of the first electrode terminal 1220-1 may be joined to the first sub-plate 1230.

Specifically, an upper surface of the core 1221 of the first electrode terminal 1220-1 may be joined to the first terminal plate 1210 and, for example, the first terminal plate 1210 and the core 1221 may be joined together through welding from above first electrode terminal 1220-1.

A lower surface of the cladding 1222 of the first electrode terminal 1220-1 may be joined to the first sub-plate 1230 and, for example, the cladding 1222 and the first sub-plate 1230 may be joined together through direct bonding from below the cladding 1222. Alternatively, the cladding 1222 and the first sub-plate 1230 may be joined together using various methods such as welding and laser welding.

That is, because materials having the same main components are joined together by joining the core 1221 of the first electrode terminal 1220 to the first terminal plate 1210 and joining the cladding 1222 of the first electrode terminal 1220 to the first sub-plate 1230, the resistance from inside the cell case to the bus bar may be reduced and the power transmission efficiency may be increased.

As another example, as illustrated in FIG. 5, the first electrode terminal 1220-2 may be formed by laminating an upper layer 1223 made of the first material having the same main component as the first terminal plate 1210, and a lower layer 1224 made of the second material having the same main component as the first sub-plate 1230, in a height-wise direction of the cap plate assembly 1000.

Specifically for example, the upper layer 1223 may be made of the first material and include aluminum, aluminum alloy, or the like, and the lower layer 1224 may be made of the second material and include copper, copper alloy, nickel, nickel alloy, or the like.

The upper and lower layers 1223 and 1224 are a laminated structure of heterogeneous materials in which facing surfaces of the upper and lower layers 1223 and 1224 are coupled to each other through structural destruction, coupling, and stabilization due to high heat and pressure.

That is, due to the heterojunction between the upper and lower layers 1223 and 1224 made of different materials in the first electrode terminal 1220-2, the first terminal plate 1210 may be easily joined to the upper layer 1223 and the first sub-plate 1230 may be easily joined to the lower layer 1224. Because materials having the same main components are joined together, the resistance from inside the cell case to the bus bar may be reduced and the power transmission efficiency may be increased.

The cap plate assembly 1000 according to some embodiments of the present invention may further include a third airtight member 1250.

The third airtight member 1250 may be coupled to the bottom of the top plate 1100 to support the first sub-plate 1230.

As illustrated in FIGS. 2 and 3, the third airtight member 1250 may be provided in a flat panel shape, and at least a portion thereof may be vertically penetrated to form an opening.

An upper surface of the third airtight member 1250 may be coupled to a lower surface of the top plate 1100, and a lower surface of the third airtight member 1250 may be coupled to an upper surface of the first sub-plate 1230. In this case, the first electrode terminal 1220 joined to the first sub-plate 1230 may be inserted through the opening.

The third airtight member 1250 may be provided between the first sub-plate 1230 and the top plate 1100 to separate the first sub-plate 1230 from the top plate 1100.

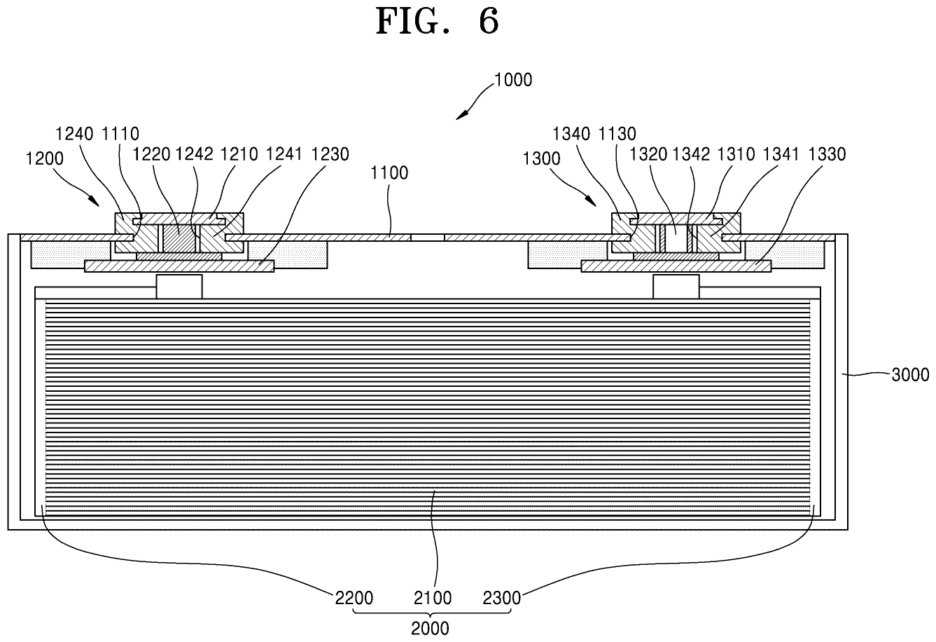

FIG. 6 is a cross-sectional view of a battery cell according to an embodiment of the present invention.

As illustrated in FIG. 6, the battery cell according to an embodiment of the present invention may include an electrode assembly 2000, a cell case 3000, and the cap plate assembly 1000.

As illustrated in FIG. 6, the electrode assembly 2000 is a structure in which a first electrode 2200 and a second electrode 2300 are provided on both surfaces of a separator 2100. Specifically, the electrode assembly 2000 may be assembled by laminating the first and second electrodes 2200 and 2300 each provided as a single plate, while disposing the separator 2100 therebetween, or by folding and laminating the separator 2100 and the first and second electrodes 2200 and 2300 in a zigzag shape.

The cell case 3000 is a case having an electrode accommodator therein to house the electrode assembly 2000, and a side thereof may be provided as an opening to receive the electrode assembly 2000 and sealed with the cap plate assembly 1000 to accommodate the electrode assembly 2000 and an electrolyte therein.

The cap plate assembly 1000 may be provided to cover the top of the cell case 3000, and first and second electrode units 1200 and 1300 respectively having first accommodation hole 1110 and second accommodation hole 1130 to connect the inside and outside of the cell case 3000 may be mounted on the top plate 1100.

The first electrode unit 1200 may include a positive electrode terminal mounted in a conductive state on the top plate 1100, and the second electrode unit 1300 may include a negative electrode terminal mounted in an insulating state on the top plate 1100. In this case, the top plate 1100 and the cell case 3000 may be charged to a positive state.

The first electrode unit 1200 may be coupled to the first accommodation hole 1110 from above and below the top plate 1100, and mounted in a conductive state on the top plate 1100 so as to be connected to the first electrode 2200.

Specifically, as illustrated in FIG. 6, the first electrode unit 1200 may include the first terminal plate 1210, the first airtight member 1240, the first electrode terminal 1220, and the first sub-plate 1230.

The first terminal plate 1210 may be held and mounted on the top plate 1100 so as to be connected to a bus bar for connecting a plurality of cells at the outside of the cell case 3000.

An upper surface of the first terminal plate 1210 may be provided in a shape corresponding to the shape of the bus bar, so as to be coupled to the bus bar, and may be surface-treated to increase the efficiency of conduction in contact with the bus bar.

A protrusion may be provided on side surfaces of the first terminal plate 1210. The protrusion may be formed by welding at least a portion of the perimeter of the first terminal plate 1210, and the side surfaces of the first terminal plate 1210 may be provided in a stepped structure with a lower portion protruding more than an upper portion.

The first terminal plate 1210 may be made of the first material and include aluminum, aluminum alloy, or the like.

A first terminal holder 1241 for holding the first terminal plate 1210 may be provided on the first airtight member 1240.

To fix the first terminal plate 1210 to the first airtight member 1240, a fixing groove into which the protrusion is inserted after the first terminal plate 1210 is mounted in the first terminal holder 1241 may be provided in the first airtight member 1240.

The fixing groove may be provided in the first airtight member 1240 in a shape corresponding to the protrusion at a position of corresponding to the perimeter of the first terminal plate 1210.

At least a portion of the first airtight member 1240 may be provided on the top plate 1100, and the first terminal holder 1241 may be provided in a surface opposite to the surface in contact with the top plate 1100, thereby separating the first terminal plate 1210 from the top plate 1100.

A first through hole 1242 may be provided in the first airtight member 1240 inside the first accommodation hole 1110. Specifically, at least a portion of the first airtight member 1240 may be provided inside the first accommodation hole 1110 to block the inner surface of the first accommodation hole 1110 from the outside.

The first airtight member 1240 may be formed through insert molding with the top plate 1100 and the first terminal plate 1210.

Because the first airtight member 1240 is insert-molded between the top plate 1100 and the first terminal plate 1210, the top plate 1100, the first airtight member 1240, and the first terminal plate 1210 may be easily coupled to each other without performing individual assembly processes.

The first airtight member 1240 may include a conductive polymer resin.

For example, the first airtight member 1240 may be made of a polymer composite including carbon nanotubes.

For example, the first airtight member 1240 may be made of a polymer composite including 0.3 vol % to 3 vol % of carbon nanotubes.

Compared to carbon black, carbon nanotubes have higher electrical conductivity, mechanical strength, mechanical and thermal shock resistance, and injection moldability. In addition, compared to carbon fiber, carbon nanotubes exhibit higher electrical conductivity, mechanical and thermal shock resistance, and injection moldability. Furthermore, carbon nanotubes may obtain an electrical resistance value similar to those of carbon black and carbon fiber even when added in a small amount, and thus flame retardancy is remarkably increased.

The first sub-plate 1230 may be made of the second material so as to be electrically connected to the first electrode terminal 1220, and connected to the bottom of the first electrode terminal 1220. For example, the first sub-plate 1230 may be provided in a flat panel shape, and a surface thereof may be joined to the first electrode terminal 1220 while the other surface thereof may be joined to a tab inside the cell case 3000, thereby electrically connecting from the tab to the first electrode terminal 1220.

The first electrode terminal 1220 may be inserted and coupled into the first through hole 1242 so as to electrically connect from the inside of the cell case 3000 to the first terminal plate 1210.

A second electrode terminal 1320 may be made of the first material including aluminum, aluminum alloy, or the like, and provided as a single body. Thus, because the first sub-plate 1230, the first electrode terminal 1220, and the first terminal plate 1210 are made of materials having the same main component, the power transmission efficiency may be increased.

The first terminal plate 1210, the first airtight member 1240, the first electrode terminal 1220, and the first sub-plate 1230 may include various modifications as illustrated in FIGS. 2 to 5, and descriptions thereof are already provided above.

The cap plate assembly 1000 may include the second electrode unit 1300 mounted in an insulating state through the second accommodation hole 1130 of the top plate 1100 so as to be connected to the second electrode 2300.

Specifically, as illustrated in FIG. 6, the second electrode unit 1300 may include a second terminal plate 1310, a second airtight member 1340, a second electrode terminal 1320, and a second sub-plate 1330.

The second terminal plate 1310 may be held and mounted on the top plate 1100 so as to be connected to the bus bar.

An upper surface of the second terminal plate 1310 may be provided in a shape corresponding to the shape of the bus bar, so as to be coupled to the bus bar, and may be surface-treated to increase the efficiency of conduction in contact with the bus bar.

A protrusion may be provided on side surfaces of the second terminal plate 1310. The protrusion may be formed by welding at least a portion of the perimeter of the second terminal plate 1310, and the side surfaces of the second terminal plate 1310 may be provided in a stepped structure with a lower portion protruding more than an upper portion.

The second terminal plate 1310 may be made of the second material and include copper, copper alloy, nickel, nickel alloy, or the like.

A second terminal holder 1341 for holding the second terminal plate 1310 may be provided on the second airtight member 1340.

To fix the second terminal plate 1310 to the second airtight member 1340, a fixing groove into which the protrusion is inserted after the second terminal plate 1310 is mounted in the second terminal holder 1341 may be provided in the second airtight member 1340.

The fixing groove may be provided in the second airtight member 1340 in a shape corresponding to the protrusion at a position of corresponding to the perimeter of the second terminal plate 1310.

At least a portion of the second airtight member 1340 may be provided on the top plate 1100, and the second terminal holder 1341 may be provided in a surface opposite to the surface in contact with the top plate 1100, thereby separating the second terminal plate 1310 from the top plate 1100.

A second through hole 1342 may be provided in the second airtight member 1340 inside the second accommodation hole 1130. Specifically, at least a portion of the second airtight member 1340 may be provided inside the second accommodation hole 1130 to block the inner surface of the second accommodation hole 1130 from the outside.

In this case, the second accommodation hole 1130 may not be completely filled with the second airtight member 1340, the second through hole 1342 smaller than the second accommodation hole 1130 may be provided inside the second accommodation hole 1130, and at least a portion of the second electrode unit 1300 may be inserted through the second through hole 1342.

The second accommodation hole 1130 may be provided as a through hole of various shapes such as circular, oval, and rectangular shapes.

The second airtight member 1340 may be provided to surround the second accommodation hole 1130 of the top plate 1100 and fix the second terminal plate 1310.

Specifically, the second airtight member 1340 may be formed through insert molding with the top plate 1100 and the second terminal plate 1310.

That is, the second airtight member 1340 may be formed by inserting a molten material around the second accommodation hole 1130 of the top plate 1100 and between the top plate 1100 and the second terminal plate 1310 in a mold in which the top plate 1100 and the second terminal plate 1310 are fixed.

Because the second airtight member 1340 is insert-molded between the top plate 1100 and the second terminal plate 1310, the top plate 1100, the second airtight member 1340, and the second terminal plate 1310 may be easily coupled to each other without performing individual assembly processes.

In addition, the second terminal plate 1310 may be easily fixed to the second airtight member 1340, and the space between the second terminal plate 1310 and the second airtight member 1340 may be sealed without a sealing member such as a gasket.

The second sub-plate 1330 may be connected to the bottom of the second electrode terminal 1320 so as to be electrically connected to the second electrode terminal 1320. For example, the second sub-plate 1330 may be provided in a flat panel shape, and a surface thereof may be joined to the second electrode terminal 1320 while the other surface thereof may be joined to a tab inside the cell case 3000, thereby electrically connecting from the tab to the second electrode terminal 1320.

The second electrode terminal 1320 may be inserted and coupled into the second through hole 1342 so as to electrically connect from the inside of the cell case 3000 to the second terminal plate 1310.

For example, the second terminal plate 1310 may be made of the first material, and the second sub-plate 1330 may be made of the second material different from the first material. That is, to electrically connect the second terminal plate 1310 and the second sub-plate 1330, which are made of different materials, the second electrode terminal 1320 formed by laminating the first and second materials may be mounted between the second terminal plate 1310 and the second sub-plate 1330 and joined to the materials having the same main components.

According to some embodiments, the second electrode terminal 1320 may be formed by laminating the first material having the same main component as the second terminal plate 1310, and the second material having the same main component as the second sub-plate 1330, in a widthwise or lengthwise direction of the top plate 1100.

Specifically, for example, the second electrode terminal 1320 may include a core made of the first material and having an upper surface joined to the second terminal plate 1310, and a cladding made of the second material, provided to surround the outer surface of the core, and having a lower surface joined to the second sub-plate 1330.

According to other embodiments, the second electrode terminal 1320 may be formed by laminating an upper layer made of the first material having the same main component as the second terminal plate 1310, and a lower layer made of the second material having the same main component as the second sub-plate 1330, in a height-wise direction of the cap plate assembly 1000.

According to various embodiments of the present invention, based on a cap plate assembly and a battery cell including the same, the battery cell may achieve high stability in electrical conductivity, sufficient mechanical strength, and high mechanical and thermal shock resistance by forming airtight members with a new conductive plastic material. Furthermore, a low electrical resistance value may be obtained by adding a small amount of the material, and thus high flame retardancy may be achieved.

As such, when a dangerous situation occurs due to a short circuit, high temperature, or overcurrent inside the battery, the flame retardancy may be maintained for a sufficient time for a user to react to or deal with the situation.

According to the afore-described embodiments of the present invention, a battery cell may achieve high stability in electrical conductivity, sufficient mechanical strength, and high mechanical and thermal shock resistance by forming battery components with a new conductive plastic material. Furthermore, when a dangerous situation occurs due to a short circuit, high temperature, or overcurrent inside the battery, the flame retardancy may be maintained for a sufficient time for a user to react to or deal with the situation.

In addition, a cap plate assembly capable of effectively preventing electrolyte leakage between a top plate and an electrode terminal by coupling the top plate and the electrode terminal through insert molding, of simplifying a manufacturing process for coupling a sealing member such as a gasket, of increasing the production efficiency, of reducing the production and process costs, of increasing a joint area between components by using a laminated structure, and of increasing the power transmission efficiency by lowering the resistance between heterogeneous materials from an electrode assembly to a bus bar, and a battery cell including the cap plate assembly may be implemented. However, the scope of the present invention is not limited to the above-described effects.

While the present invention has been particularly shown and described with reference to embodiments thereof, it will be understood by one of ordinary skill in the art that various changes in form and details may be made therein without departing from the scope of the present invention as defined by the following claims.

What is claimed is:

1. A cap plate assembly provided to cover a cell case of a secondary battery, the cap plate assembly comprising:
a top plate having at least a portion penetrated to form a first accommodation hole for connecting an inside and outside of the cell case; and
a first electrode unit coupled to the first accommodation hole from above and below the top plate,
wherein the first electrode unit comprises:
a first terminal plate held and mounted on the top plate so as to be connected to a bus bar for connecting a plurality of cells at the outside of the cell case;
a first airtight member comprising a first terminal holder for holding the first terminal plate, further comprising a first through hole provided inside the first accommodation hole, provided to separate the first terminal plate from the top plate, and made of a polymer composite comprising carbon nanotubes;
a first electrode terminal inserted and coupled into the first through hole so as to electrically connect from the inside of the cell case to the first terminal plate; and
a first sub-plate electrically connected to the first electrode terminal, and connected to a bottom of the first electrode terminal.

2. The cap plate assembly of claim 1, wherein the first airtight member is made of a polymer composite comprising 0.3 vol % to 3 vol % of carbon nanotubes.

3. The cap plate assembly of claim 1, wherein the first airtight member is insert-molded with the top plate and the first terminal plate so as to be formed between the top plate and the first terminal plate.

4. The cap plate assembly of claim 1, wherein the first electrode terminal is formed by laminating a first material having the same main component as the first terminal plate, and a second material having the same main component as the first sub-plate, in a widthwise or lengthwise direction of the top plate.

5. The cap plate assembly of claim 4, wherein the first electrode terminal comprises:
a core made of the first material and having an upper surface joined to the first terminal plate; and
a cladding made of the second material, provided to surround an outer surface of the core, and having a lower surface joined to the first sub-plate.

6. The cap plate assembly of claim 1, wherein the first electrode terminal is formed by laminating an upper layer made of a first material having the same main component as the first terminal plate, and a lower layer made of a second material having the same main component as the first sub-plate, in a height-wise direction of the cap plate assembly.

7. The cap plate assembly of claim 1, further comprising a third airtight member coupled to a bottom of the top plate to support the first sub-plate.

8. A battery cell comprising:
an electrode assembly comprising first and second electrodes provided on both surfaces of a separator;
a cell case having an electrode accommodator to house the electrode assembly; and
a cap plate assembly provided to cover a top of the cell case, and comprising a first electrode unit mounted in a conductive state on a top plate comprising a first accommodation hole for connecting an inside and outside of the cell case, so as to be connected to the first electrode, and a second electrode unit mounted in an insulating state through a second accommodation hole of the top plate so as to be connected to the second electrode,
wherein the first electrode unit comprises:
a first terminal plate held and mounted on the top plate so as to be connected to a bus bar for connecting a plurality of cells at the outside of the cell case;
a first airtight member comprising a first terminal holder for holding the first terminal plate, further comprising a first through hole provided inside the first accommodation hole, provided to separate the first terminal plate from the top plate, and made of a polymer composite comprising carbon nanotubes;
a first electrode terminal inserted and coupled into the first through hole so as to electrically connect from the inside of the cell case to the first terminal plate; and
a first sub-plate electrically connected to the first electrode terminal, and connected to a bottom of the first electrode terminal.

9. The battery cell of claim 8, wherein the first airtight member is made of a polymer composite comprising 0.3 vol % to 3 vol % of carbon nanotubes.

10. The battery cell of claim 8, wherein the second electrode unit comprises:
a second terminal plate held and mounted on the top plate so as to be connected to the bus bar;
a second airtight member comprising a second terminal holder for holding the second terminal plate, further comprising a second through hole provided inside the second accommodation hole, and provided to separate the second terminal plate from the top plate;
a second electrode terminal inserted and coupled into the second through hole so as to electrically connect from the inside of the cell case to the second terminal plate; and
a second sub-plate electrically connected to the second electrode terminal, and connected to a bottom of the second electrode terminal.

11. The battery cell of claim 10, wherein the second electrode terminal is formed by laminating a first material having the same main component as the second terminal plate, and a second material having the same main component as the second sub-plate, in a widthwise or lengthwise direction of the top plate.

12. The battery cell of claim 11, wherein the second electrode terminal comprises:
a core made of the first material and having an upper surface joined to the second terminal plate; and
a cladding made of the second material, provided to surround an outer surface of the core, and having a lower surface joined to the second sub-plate.

13. The battery cell of claim 10, wherein the second electrode terminal is formed by laminating an upper layer made of a first material having the same main component as the second terminal plate, and a lower layer made of a second material having the same main component as the second sub-plate, in a height-wise direction of the cap plate assembly.
